(19) United States
(12) Patent Application Publication
(10) Pub. No.: US 2025/0002652 A1
(43) Pub. Date: Jan. 2, 2025

(54) METHOD AND PROCESS TO MODIFY POLYMERS ON-SITE THE MAIN PROCESS SITE

(71) Applicant: KEMIRA OYJ, Helsinki (FI)

(72) Inventors: Perttu HEISKA, Helsinki (FI); Xavier DE SEQUERA, Barcelona (ES); Eric PADOVANI, Strasbourg (FR); Asko KARPPI, Espoo (FI)

(21) Appl. No.: 18/703,535

(22) PCT Filed: Oct. 28, 2022
(86) PCT No.: PCT/FI2022/050709

§ 371 Date: Apr. 22, 2024

(30) Foreign Application Priority Data
Oct. 28, 2021 (FI) 20216117

(51) Int. Cl. C08G 73/02

(52) U.S. Cl. CPC C08G 73/0286

(57) ABSTRACT

The invention relates to a process to modify polymers on-site the main process site. The process comprises on-site the main process site a receiving section (11) configured to receive an adduct solution as an interim polymer product for a process polymer of the main process site in solids contents of 15-60 wt-%, preferably 20-60 wt-%, more preferably 30-60 wt-%, a crosslinking section (13) configured to crosslink polymers of the adduct solution and a final section (14) configured to provide a ready-to-use solution with the crosslinked polymers to the main process as the process polymer on-site the main process site. The invention also relates to a method configured to modify polymers on-site at a main process site.

### TECHNICAL FIELD

In general, present invention relates to methods and processes for modifying polymers on-site the main process site. More especially the present invention relates to a method according to preamble part of the independent method claim and to a process to according to preamble part of the independent process claim.

### BACKGROUND

In manufacturing of polymers, in particular crosslinked polymers, for example PAE, viscosity in a crosslinking step limits end product performance. Wet strength resins are used to manufacture wet strengthened fiber products. Polymers, in particular crosslinked polymers such as PAE (polyaminoamide-epichlorohydrin) are commonly used as wet strength additives in commercial applications of wet strength resins. Glyoxylated polyacrylamide (GPAM) is generally used in a variety of paper grades to enhance the dry and temporary wet strength. Typically, intermediate PAE material is after an EPI (epichlorohydrin) addition step in order to increase product charge in a following charge formation, in particular a ring closure, —step, processed at about 20-wt-% solid content, in which formation of azetidinium rings to the polymer chain and liberation of chloride ions takes place, and to increase molecule size of the end product polymer using interchain-polymerization, i.e. in a crosslinking-step. Both of these reactions take place in a large, stirred tank reactor, and the crosslinking is stopped to about 150 mPas viscosity level with acid addition and quick cooling. Aim is to reach high charge and molecular size giving good strength properties in the application but not to increase viscosity too much to cause problems in product handling. Thus, there is an inconsistency between the product solids content and the weight average molecular weight (Mw) when conventional stirred tank reactor is used: if you want to reach an end product with higher weight average molecular weight (Mw) and better strength performance you need to decrease solids content in the crosslinking step to keep the viscosity in a convenient level—but furthermore this increases logistics costs. Typically, solid content of the end product is between 12-30 wt-%, often 21-25 wt-%. Hence logistic costs play an important role and potential use is limited by distance from the manufacturing plant.

There is already a known technology to overcome low solids content challenge in production of polymers. In this technology an “adduct” material is used. Adduct material is obtained as a product from earlier production stages. Challenges in the adduct technology are increased fixed costs when the process time is split to two different locations and additional logistics costs from the crosslinking plant to the customer. In the PAE (polyaminoamide-epichlorohydrin) the adduct is obtained from a reaction of a polyaminoamide backbone with epichlorohydrin, and this step is carried over at high solids content, preferably over 50% w/w. Then the high solids content adduct is transported to another plant for the crosslinking step. The other plant is delivering the end product to the shorter distance customers in a normal solids content.

An object of the invention is to create a method and a process to modify polymers on-site the main process site, in which the disadvantages and problems of prior art are eliminated or at least minimized.

Another object of the invention is to create an improved method and process to modify polymers on-site the main process site, in which logistics costs are significantly decreased.

Another object of the invention is to create an improved method and process to modify polymers on-site the main process site, in which especially the product strength performance via higher molecule weight is improved.

### SUMMARY

In order to achieve the above-mentioned objects, the method according to the invention is mainly characterized by the features of the characterizing clause of the independent method claim. The process according to the invention is mainly characterized by the features of the characterizing clause of the independent process claim. Advantageous embodiments and features are disclosed in the dependent claims.

In this description by the expression on-site the main process site is meant a method of modifying polymers conducted or a process configured to modify polymers located in immediate vicinity of a main process site, which can be a customer or a user process site or a satellite process or a paper or board production site utilizing the modified polymers provided by the method or the process in the main process site. The adduct solution contains all necessary monomers reacted, and no monomers are added to the solution on-site.

According to the invention the process to modify polymers on-site the main process site comprises on-site the main process site a receiving section configured to receive an adduct solution as an interim polymer product for a process polymer of the main process site in solids contents of 15-60 wt-%, preferably 20-60 wt-%, more preferably 30-60 wt-%, a crosslinking section configured to crosslink polymers of the adduct solution and a final section configured to provide a ready-to-use solution with the crosslinked polymers to the main process as the process polymer on-site the main process site.

According to an advantageous feature the process further comprises on-site the main process site a charge formation, in particular a ring closure, section before the crosslinking section configured to charge formation, in particular ring closing, of polymers of the adduct solution received form the receiving section.

According to an advantageous feature the charge formation, in particular a ring closure, section and the crosslinking section are combined to one united section on-site the main process site.

According to an advantageous feature the process further comprises on-site the main process site a base addition source and/or a dilution water source connected to the charge formation, in particular a ring closure, section and/or to the crosslinking section.

According to an advantageous feature the process further comprises on-site the main process site a base addition source and/or a dilution water source connected to the combined on-site the main process site charge formation, in particular a ring closure, and the crosslinking section.

According to an advantageous feature the process further comprises on-site the main process site an acid addition source connected to the crosslinking section or to the combined on-site the main process site charge formation, in particular a ring closure, and the crosslinking section and pH of the process is controlled by controlling the acid addition of the acid addition source advantageously such that pH value of the being <pH 4 is modified to pH>6 in the charge formation, in particular in the ring closure, pH value is modified to be after the crosslinking to <pH 6. Thus, the crosslinking is advantageously stopped by acid addition to bring the pH-value below 6. Alternatively, advantageously the crosslinking can be stopped by dilution or by using combination of acid addition and dilution.

According to an advantageous feature the process comprises temperature control device, for example a heat exchanger or a jacket heating device, configured to control temperature of the solution in the process and that the temperature of the process is controlled by the temperature control device advantageously such that in the crosslinking stage the temperature range is 30-80° C. and that in the charge formation, in particular a ring closure, stage the temperature range is 40-80° C., preferably 45-60° C., to enhance the reaction. Alternatively advantageously, the temperature can be controlled by adding to the adduct solution hot liquid, preferably hot water. More advantageously, the heat energy needed in the process steps is fully obtained from the dilution water heat energy, wherein the dilution water is heated and its temperature is adjusted according to the need of the process step.

According to an advantageous feature the process is a batch process or a continuous process.

According to an advantageous feature the process comprises process equipment for the process sections and the process equipment are located in a movable construction configured to be located in connection with the main process for execution of the process. The process equipment can also be located in a non-movable construction in connection with the main process site.

According to an advantageous feature the process equipment comprises a connection to the main process of the main process site configured to provide the ready-to-use solution with the crosslinked polymers to the main process as the process polymer.

According to the invention the method configured to modify polymers on-site at a main process site, in the method on-site the main process site:
an adduct solution for a crosslinked polymer product for a main process of the main process site is provided to the main process site as an interim polymer product for a process polymer of the main process site in solid contents of 15-60 wt-%, preferably 20-60 wt-%, more preferably 30-60 wt-%,
the adduct solution is on-site the main process site modified by crosslinking for crosslinking polymers of the adduct solution to a ready-to-use polymer product and
the ready-to-use polymer solution with the crosslinked polymers is provided to the main process as the process polymer on-site the main process site.

According to an advantageous feature in the method on-site the main process site before the crosslinking of the polymers of the adduct solution the adduct solution is treated by charge formation, in particular by ring closing of the polymers of the adduct solution.

According to an advantageous feature in the method the solution is diluted before the charge formation, in particular a ring closure, stage and the crosslinking stage to maximum 30 wt-%, typically maximum 20 wt-%, even maximum 16 wt-%.

According to an advantageous feature in the method pH of the solution is modified on-site the main process site, performing the charge formation, in particular the ring closure, advantageously such that pH value of the being <pH 4 is modified to pH>6 in the charge formation, in particular in the ring closure, pH value is modified to be after the crosslinking to <pH 4.

According to an advantageous feature in the method solids content of the solution is modified on-site the main process site to 8-45 wt %, preferably 10-30 wt %, more preferably 14-20 wt % in the crosslinking stage.

According to an advantageous feature in the method temperature of the solution is modified on-site the main process site advantageously such that in the crosslinking stage the temperature range is 30-80° C. and that in the charge formation, in particular a ring closure, stage the temperature range is 40-80° C., preferably 45-60° C., to enhance the reaction.

According to an advantageous feature in the method weight average molecular weight (Mw) of the polymer of the adduct solution prior to the charge formation stage is 2000-200 000 Da, preferably 3000-150 000 Da, more preferably 3000-100 000 Da, and in the crosslinking stage the weight average molecular weight (Mw) is 100 000-1000 000 Da, preferably 150 000-500 000 Da, more preferably 200 000-400 000 Da. The weight average molecular weights for the present purposes are measured by using SEC/GPC determination with PEO (polyethyleneoxide) calibration as described in the following. The weight average molecular weight (Mw) is determined by size-exclusion chromatography (SEC) using Agilent 1100 SE chromatography equipment with integrated pump, autosampler and degasser. Eluent is a buffer solution (0.3125 M CH₃COOH+0.3125 M CH₃COONa) with a flow rate of 0.5 ml/min at 35° C. Typical sample concentration is 2-4 mg/ml, with an injection volume of 50 μl. Ethylene glycol (1 mg/ml) is used as a flow marker. The used column set consists of three columns (one TSKgel PWXL guard column and two TSKgel GMPWXL columns). Refractive index detector by Agilent is used for detection (T=35° C.). Molecular weight is determined using conventional column calibration with poly (ethylene oxide)/poly (ethylene glycol) narrow molecular weight distribution standards (Polymer Standards Service).

According to an advantageous feature in the method the crosslinking is performed continuously processing and the charge formation is performed continuously processing. The continuous process can be a CSTR (continuous stirred-tank) reactor process or a loop reactor process or a pipe reactor process. Alternatively the crosslinking or the charge formation or both can be performed batchwise or any combination of continuous and batchwise process.

According to the invention the system configured to execute the process and the method comprises process equipment comprising devices for the crosslinking, for example a stirred tank reactor, continuous stirred tank reactor, pipe reactor, loop reactor or any combination of these, located in a movable construction configured to be located in connection with the main process for execution of the process according to the invention.

According to an advantageous feature the system comprises devices for the charge formation, for example a stirred tank reactor, continuous stirred tank reactor, pipe reactor, loop reactor or any combination of these, located in a movable construction configured to be located in connection with the main process for execution of the process according to the invention.

According to an advantageous feature the system comprises one or more in-line mixer/s, which can be static mixer/s or equipped with motor.

According to an advantageous feature the system comprises flow generating means, for example at least one pump.

According to an advantageous feature the system comprises at least one temperature control device, for example a heat exchanger or a jacket heating device.

According to an advantageous feature the system comprises a connection to the main process of the main process site configured to provide the ready-to-use solution with the crosslinked polymers to the main process as the process polymer.

According to an advantageous feature in the charge formation step (advantageously the ring closure step) and in the crosslinking step the process is be monitored with in-line measurements and/or analyzing process samples. The followed parameters can include temperature—in addition to processing time—temperature, energy, viscosity, solid content, conductivity, chloride ion concentration and pH. Also a separate torque measurement or Ampere measurement of the agitator, pump or a dedicated measurement device can used to determine the viscosity level of the process solution and reaction conversion. Solid content measurement can be conducted indirectly using for example density, refraction index or sonic velocity measurement.

By the method and the process according to the invention many advantages are achieved: The logistics costs are significantly decreased compared to the conventional processes. Also, a fresh product via production just before or short time before the final use (no need to store that long times) is provided and thus, the fresh product can be produced without charge decay. There is no need to handle harmful epichlorohydrin at the customer site. Also, the weight average molecular weight (Mw) of the product can be modified on-site the main process site. Thus, the storing time is short and fresh solution is provided to the process of the main process site.

### BRIEF DESCRIPTION OF THE DRAWINGS

In the following the invention is explained in detail with reference to the accompanying drawing to which the invention is not to be narrowly limited.

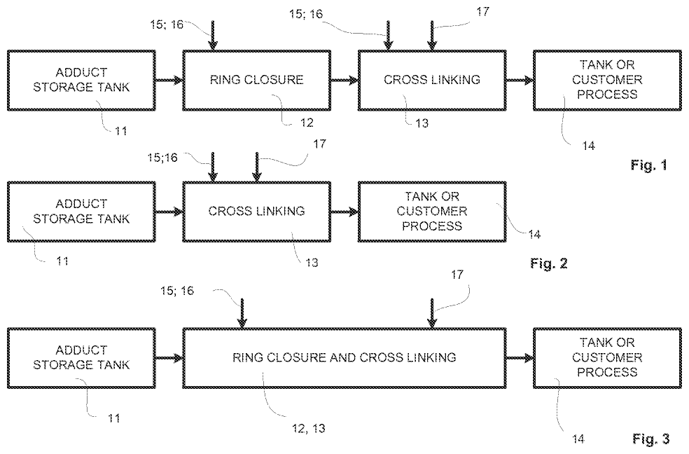

In FIG. 1 is schematically shown an advantageous example of a process configured to modify polymers on-site the main process site.

In FIG. 2 is schematically shown another advantageous example of a process configured to modify polymers on-site the main process site.

In FIG. 3 is schematically shown another advantageous example of a process configured to modify polymers on-site the main process site.

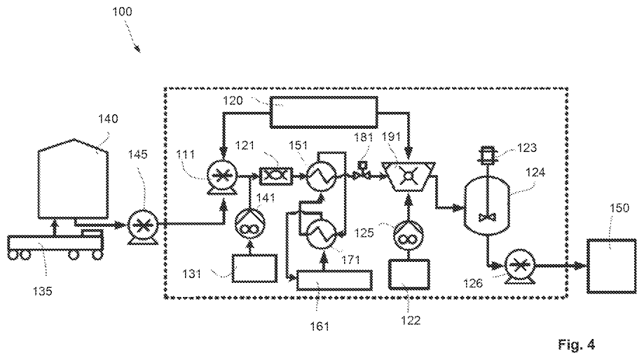

In FIG. 4 is schematically shown another advantageous example of a process configured to modify PAE polymers on-site the main process site in more detail.

### DETAILED DESCRIPTION

During the course of the following description like numbers and signs will be used to identify like elements according to the different views which illustrate the invention and its advantageous examples. In the figures some repetitive reference signs have been omitted for clarity reasons.

In the example of FIG. 1 is shown an example of a process 10, in which charge formation, in particular a ring closure, and crosslinking sections 12, 13 are located and charge formation, in particular a ring closure, and crosslinking stages are performed on-site. The adduct is received to a adduct storage tank 11 forming a receiving section 11 for a receiving stage located on-site and pumped to charge formation, in particular a ring closure, section 12 for a charge formation, in particular a ring closure, stage in a charge formation, in particular a ring closure, section 12. The charge formation, in particular a ring closure, stage in the charge formation, in particular a ring closure, section 12 is performed in a batch reactor or continuously in a pipe or loop reactor or in a combination of these forming the charge formation, in particular a ring closure, section 12. In the charge formation, in particular a ring closure, stage from the adduct is formed azetidium rings by closure of chlorohydrin group by and endothermic reaction. During the charge formation, in particular a ring closure, stage chloride ions are formed and charge development occurs, during which conductivity, pH and Chloride ion concentration is followed. During the charge formation, in particular a ring closure, stage crosslinking is tried to avoid e.g. by diluting the process solution and thus the charge formation, in particular a ring closure, section 12 is provided with optional base and/or optional dilution water sources 15, 16 for optional base and/or dilution water addition. From the charge formation, in particular a ring closure, section 12 the solution is transferred to a crosslinking section 13 for a crosslinking stage. The crosslinking stage in the crosslinking section 13 is conducted in a batch reactor or continuously in a pipe or loop reactor or in a combination of these forming the crosslinking section 13. The charge formation, in particular a ring closure, stage and the crosslinking stage can also be conducted in a combined section of the charge formation, in particular a ring closure, section 12 and the crosslinking section 13 as shown in the example of the FIG. 3. The crosslinking of the polymers is caused by increasing the pH and/or increasing the temperature in the crosslinking section 13 and during the crosslinking stage crosslinking time, viscosity and/or torque are followed to follow and control the reaction conversion. The crosslinking is stopped by acid addition, e.g. sulfuric and/or formic acid addition. The crosslinking section 13 is provided with optional base and/or optional dilution water sources 15, 16 for optional base and/or dilution water addition and with optional acid source 17 for optional acid addition. The process 10 further comprises after the crosslinking section 13 and the crosslinking stage a final section 14 for a ready-to-use stage. The final section 14 is formed of a tank for intermediate storing of the solution for the customer process and/or a connection to a customer process for providing the solution to the customer process for further utilization.

In the process 10 the pH can be modified by using suitable base, for example NaOH, or KOH, provided from the optional base source/-s 15 to the charge formation, in particular a ring closure, section 12 during the charge formation, in particular a ring closure, stage and/or to the crosslinking section 13 during the crosslinking stage. In the process 10 the solids content can be modified by using suitable base, for example NaOH, or KOH, provided from the optional base source/-s 15 to the charge formation, in particular a ring closure, section 12 during the charge formation, in particular a ring closure, stage and/or to the crosslinking section 13 during the crosslinking stage. The solids content can also be modified by adding of other component like dilution water from the dilution water source 16 in one or several steps. The added component can be also the same component as in the pH and in temperature modification. The temperature of the solution can be modified by adding of other component in different temperature to the solution, preferably water or steam as the dilution water from the dilution water source 16 to the charge formation, in particular a ring closure, section 12 during the charge formation, in particular a ring closure, stage and/or to the crosslinking section 13 during the crosslinking stage. The added component can be also the same component as used in the modification of the pH and/or the solids content. The temperature can also be controlled by using indirect means like a temperature control device, for example a heat exchanger or a jacket heating device. The pressure the process 10 can be modified by modifying the pressure of the process liquid, for example mixing 2:1 w/w adduct in 30 wt-% solids at 20° C. with water at 130° C./1.8 barg results in PAE 20 wt-% solids at 61° C. These modifications of the state of the processed solution can be done simultaneously or in any order and the residence time during and after the modifications can be varied. In case a pipe reactor is used in any of the sections 12; 13 the residence time can be adjusted by adjusting flow speed of the solution during the stages in the sections. In this example the charge formation, in particular a ring closure, stage and the crosslinking stage are conducted on-site and thus, the adduct may be provided in 45-50 wt-% solids contend and the process needs less than 50 wt-% azetidinium. In some cases the charge formation, in particular a ring closure, stage and be performed by converting selected places in molecules to epoxide groups via caustic treatment, which cannot be done at “a mother site” as the product is not stabile. The caustic treatment reduces the AOX.

In the example of FIG. 2 is shown an example of a process 10, in which crosslinking section is located and crosslinking stage is performed on-site. The adduct is received to a adduct storage tank 11 forming a receiving section 11 for a receiving stage located on-site and pumped a crosslinking section 13 for a crosslinking stage. The crosslinking stage in the crosslinking section 13 is conducted in a batch reactor or continuously in a pipe or loop reactor or in a combination of these forming the crosslinking section 13. The crosslinking of the polymers is caused by increasing the pH and/or increasing the temperature in the crosslinking section 13 and during the crosslinking stage crosslinking time, viscosity and/or torque are followed to follow and control the reaction conversion. The crosslinking is stopped by acid addition, e.g. sulfuric and/or formic acid addition. The crosslinking section 13 is provided with optional base and/or optional dilution water sources 15, 16 for optional base and/or dilution water addition and with optional acid source 17 for optional acid addition. The process 10 further comprises after the crosslinking section 13 and the crosslinking stage a final section 14 for a ready-to-use stage. The final section 14 is formed of a tank for intermediate storing of the solution for the customer process and/or a connection to a customer process for providing the solution to the customer process for further utilization.

In the process 10 the pH can be modified by using suitable base, for example NaOH or KOH, provided from the optional base source/-s 15 to the charge formation, in particular a ring closure, section 12 during the charge formation, in particular a ring closure, stage and/or to the crosslinking section 13 during the crosslinking stage. In the process 10 the solids content can be modified by using suitable base, for example NaOH or KOH, provided from the optional base source/-s 15 to the crosslinking section 13 during the crosslinking stage. The solids content can also be modified by adding of other component like dilution water from the dilution water source 16 in one or several steps. The added component can be also the same component as in the pH and in temperature modification. The temperature of the solution can be modified by adding of other component in different temperature to the solution, preferably water or steam as the dilution water from the dilution water source 16 to the crosslinking section 13 during the crosslinking stage. The added component can be also the same component as used in the modification of the pH and/or the solids content. The temperature can also be controlled by using indirect means like a temperature control device, for example a heat exchanger or a jacket heating device. The pressure the process 10 can be modified by modifying the pressure of the process liquid. These modifications of the state of the processed solution can be done simultaneously or in any order and the residence time the residence time can be adjusted by adjusting flow speed of the solution during the stages in the sections. In this example the charge formation, in particular a ring closure, stage is done, at least partly at a “mother site” and the crosslinking stage at on-site the main process site, which provides for a shorter and simpler on-site the main process site process. The adduct is advantageously in in 30 wt-%-35 wt-% solids content and a possibility of providing epoxide groups in the molecule to about some 15 wt-% is achieved. The adduct has advantageously more than 50 wt-% azetidinium and the caustic treatment to form some epoxides also leads to AOX reduction.

In the example of FIG. 3 is shown an example of a process 10, in which the charge formation, in particular a ring closure, and the crosslinking section are located and the charge formation, in particular a ring closure, and crosslinking stage is performed on-site in in the combined section of the charge formation, in particular a ring closure, section 12 and the crosslinking section 13.

In an advantageous example in the charge formation stage the main reaction is the ring closure of chlorohydrin groups, to hydroxy-azetidinium rings and formation of Chloride ions. The ring closure reaction is conducted at pH 6-8 and it is an endothermic process. The quaternary azetidinium group formed from secondary amine and ECH is very stable under these conditions. In this reaction the goal is to achieve a high degree of conversion—that is as high concentration of chloride ions as possible, which is considered to be reached when around 75 wt-% of all original organic chlorine is converted into chloride ions. Before beginning of the heating step, the conversion level is around 15 wt-%. The goal is reached with lowest possible viscosity increase—that is as little as possible of crosslinking reaction shall take place in this step. To avoid crosslinking reactions at this stage the solution is diluted as much as possible before the next stage.

In FIG. 4 is schematically shown an advantageous example of main parts and steps of a process configured to a system 100 to modify polymers on-site the main process site referring to PAE (polyaminoamide-epichlorohydrin) production, in which high solids adduct is transported by transport means 135 from a manufacturing plant (not shown) to an adduct storage tank 140 which can be a tank located near the end user, the customer or a movable tank. The adduct storage tank 140 can comprise temperature controlling means for example cooling means—for controlling the temperature of the adduct depending on the adduct stability. From the adduct storage tank 140 the adduct is fed by an adduct pump 145, for example a mono or a screw or a corresponding type of pump enabling good pumping against high back pressure, to suction side of an adduct process pump 111, whereto also process water is fed as an external output from a selected location 120 of a process water method of a paper/board machine. The adduct feed is diluted to selected processing solids range lower than in a conventional crosslinking step to enable higher range for viscosity & particle size growth. The diluted adduct feed is fed to a static mixer 121, wherein also NaOH is fed as an external output from a container 131 via NaOH dosing pump 141 to increase the pH to a reaction level. Mixing of the NaOH to the diluted adduct is done in the static mixer 121. Thereafter the diluted adduct stream is heated to boost the crosslinking. The crosslinking reaction takes place in a reactor 151, 171, for example a tubular pipe reactor, after the heating by heat from an external output, for example a steam source or an electric heater 161, until the desired viscosity and/or molecule size of the product is reached-a length of the pipe reactor 151, 171 depends on the process capacity and the targeted crosslinking degree and the end product molecular size. A pressure control valve 181 is used to adjust the pressure in the reactor 151, 171. After the crosslinking in the reactor 151, 171 the pH is decreased by acid, for example H2SO4 pumped by a dosing pump 125 as an external output from H2SO4 container 122, mixing by a mixer 191 or a static mixer to stop the crosslinking reaction, when desired. At the same time, it may be advantageous to dilute the stream to decrease temperature, which also stops the crosslinking reaction. Thereafter the crosslinked PAE product is collected to a small pumping tank 124 provided with a mixer 123 and pumped by a product pump 126 forward to the end process 150, either to a storage tank or straight to the paper or board machine.

This example is applicable also in on-site glyoxylation, in which the feed chemicals are fed from storage tanks 140 or containers 131 and the crosslinking step proceeds as above. As main parts a system configured to modify polymers on-site the main process site in this example comprises the adduct storage tank 140 configured to provide the source for the adduct of the crosslinked or glyoxylated polymer, the NaOH container 131 to increase pH-value of the adduct in order to start the crosslinking reaction, the crosslinking reactor 151, 171 with a heating source 161 configured to maintain the crosslinking reaction, the reaction stopping chemical container 122 configured to feed a reaction stopping chemical to the crosslinking reactor 151, 171 at the time the desired crosslinking degree is achieved, the reaction stopping chemical mixer 191 configured to mix the reaction stopping chemical to the adduct fed from the reactor 151,171 and the pumping tank 124 configured to feed the adduct to an end tank or process 150. Very advantageously the NaOH container 131, the crosslinking reactor 151, 171 with the heating source 161, the reaction stopping chemical container 122, the reaction stopping chemical mixer 191 and the pumping tank 124 are in a movable unit, which in the example of the figure is indicated by the parts inside the dashed line. The method advantageously also comprises the connection to the selected location 120 of the process water method configured to provide dilution water to the adduct feed and to dilute the adduct feed to selected processing solids range, which advantageously also is in the movable unit. As the main steps of the method to modify polymers on-site the main process site the process comprises steps of providing the adduct of the crosslinked or glyoxylated polymer from the adduct storage tank 140, providing NaOH from the NaOH container 131 to increase pH-value of the adduct to start the crosslinking reaction, crosslinking the adduct in the crosslinking reactor 151, 171, heating the adduct in the crosslinking reactor 151, 171 by the heating source 161 to maintain the crosslinking reaction, feeding the reaction stopping chemical from the reaction stopping chemical container 122 to the crosslinking reactor 151, 171 at the time the desired crosslinking degree is achieved, mixing the reaction stopping chemical to the adduct fed from the reactor 151,171 in the reaction stopping chemical mixer 191, feeding the adduct to a pumping tank 124 and feeding the adduct to the end tank or process 150. Very advantageously the steps of providing NaOH from the NaOH container 131 to increase pH-value of the adduct to start the crosslinking reaction, crosslinking the adduct in the crosslinking reactor 151, 171, heating the adduct in the crosslinking reactor 151, 171 by the heating source 161 to maintain the crosslinking reaction, feeding the reaction stopping chemical from the reaction stopping chemical container 122 to the crosslinking reactor 151, 171 at the time the desired crosslinking degree is achieved, mixing the reaction stopping chemical to the adduct fed from the reactor 151,171 in the reaction stopping chemical mixer 191, feeding the adduct to a pumping tank 124 are processed in the movable unit, which in the example of the figure is indicated by the parts inside the dashed line. Advantageously the process further comprises the step of diluting the adduct to selected processing solids range by dilution water from the selected location 120 of the process water method configured to provide dilution water to the adduct feed and the step of diluting the adduct is processed in the movable unit. Thus, in this example the process to conduct the crosslinking step in higher solids content is provided. For the process, the feed chemicals are fed from storage tanks or intermediate bulk containers. In the process the crosslinking process provides a high solids intermediate crosslinking-step.

### Example 1

A polyaminoamide-epichlorohydrin resin was prepared in a two-stage process: First diethylenetriamine and adipic acid in a 1:1 mole ratio were condensed at 180° C. and then diluted to 53% solids and cooled below 20° C. The second step involved reacting the polyaminoamide with epichlorohydrin in a 1:1 amine-epichlorohydrin ratio at 15-19° C. for at least 18 hours. After that maturing period, the reaction mixture is diluted to 40-45% solids and acidified with sulfuric and formic acid to pH 3.0-3.5. The resulting resin is stable for 60 days at room temperature. Viscosity 250 mPa's at 20° C., DCP 453 ppm, CPD 254 ppm.

### Example 2

The resin from Example 1 was diluted to 20% solids and its pH adjusted to 7 with sodium hydroxide. The ring closure step was performed as follows: The sample was heated at 3° C./10 min until reaching 55° C. and kept at that temperature until reaching constant conductivity. That material can be immediately used for cross-linking or stabilized for storage by acidification to pH 3.0-3.5. Viscosity: 18 mPas at 20° C.

### Example 3

The resin from Example 1 was diluted to 25% solids and its pH adjusted to 7 with sodium hydroxide. The ring closure step was performed as follows: The sample was heated at 3° C./10 min until reaching 50° C. and kept at that temperature until reaching constant conductivity. That material can be immediately used for cross-linking or stabilized for storage by acidification to pH 3.0-3.5. Viscosity: 30 mPas at 20° C.

### Example 4

The resin from Example 3 was diluted to 15.5% solids and its pH adjusted to 10 with sodium hydroxide. The cross-linking step was performed as follows: The sample was heated at 3° C./10 min until reaching 65° C. and kept at that temperature until achieving a viscosity value of 55 mPas at 20° C. Then the material was cooled below 20° C. and acidified to pH 3.5-4.0.

In the description in the foregoing, although some functions have been described with reference to certain features and examples, those functions may be performable by the other features and examples whether described or not. Although features have been described with reference to the certain examples, those features may also be present in the other examples whether described or not.

Above only some advantageous examples of the inventions have been described to which examples the invention is not to be narrowly limited and many modifications and alterations are possible within the invention as defined in the following claims.

### REFERENCE SIGNS USED IN THE DRAWING

10 process
11 adduct storage
12 charge formation, in particular a ring closure,
13 cross linking
14 tank or connection to next process
15 base addition source
16 dilution water source
17 acid addition source
100 system to modify crosslinked or glyoxylated polymers
111 adduct process pump
121 static mixer
131 NaOH container
141 NaOH dosing pump
151 tubular reactor
161 steam source or electric heater
171 tubular reactor
181 pressure control valve
191 mixer
120 process water from paper/board machine
125 H2SO4 dosing pump
122 H2SO4 container
123 mixer
124 pumping tank
126 product pump
135 transport means
140 adduct storage tank
145 adduct pump
150 end tank or process

1. A process to modify polymers on-site a main process site, wherein the process comprises on-site the main process site a receiving section configured to receive an adduct solution as an interim polymer product for a process polymer of the main process site in solids contents of 15-60 wt-%, preferably 20-60 wt-%, more preferably 30-60 wt-%, a crosslinking section configured to crosslink polymers of the adduct solution and a final section configured to provide a ready-to-use solution with the crosslinked polymers to the main process as the process polymer on-site the main process site.

2. The process according to claim 1, wherein the process further comprises on-site the main process site a charge formation section, in particular a ring closure section, before the crosslinking section configured to charge formation, in particular ring closing, of polymers of the adduct solution received from the receiving section.

3. The process according to claim 1, wherein the charge formation section, in particular a ring closure section, and the crosslinking section are combined to one united section on-site the main process site.

4. The process according to claim 1, wherein the process further comprises on-site the main process site a base addition source and/or a dilution water source connected to the charge formation section, in particular a ring closure section, and/or to the crosslinking section.

5. The process according to claim 1, wherein the process further comprises on-site the main process site a base addition source and/or a dilution water source connected to the combined on-site the main process site charge formation section, in particular a ring closure section, and the crosslinking section.

6. The process according to claim 1, wherein the process further comprises on-site the main process site an acid addition source connected to the crosslinking section or to a combined on-site the main process site charge formation section, in particular a ring closure section, and the crosslinking section and wherein pH of the process is controlled by controlling acid addition of the acid addition source advantageously such that pH value when being <pH 4 is modified to pH>6 in the charge formation section, in particular in the ring closure section, and wherein pH value is modified to be <pH 6 after the crosslinking section.

7. The process according to claim 1, wherein the process comprises a temperature control device configured to control temperature of the adduct solution in the process and temperature of the process, advantageously such that in the crosslinking section stage the temperature range is 30-80° C. and wherein in the charge formations section, in particular a ring closure section, the temperature range is 40-80° C., preferably 45-60° C., to enhance the reaction.

8. The process according to claim 1, wherein the process is a batch process or a continuous process.

9. The process according to claim 1, wherein the process comprises process equipment for process sections and the process equipment are located in a movable construction configured to be located in connection with the main process for execution of the process.

10. The process according to claim 9, wherein the process equipment comprise a connection to the main process of the main process site configured to provide the ready-to-use solution with the crosslinked polymers to the main process as the process polymer.

11. A method configured to modify polymers on-site at a main process site, wherein on-site the main process site:
an adduct solution for a crosslinked polymer product for a main process of the main process site is provided to the main process site as an interim polymer product for a process polymer of the main process site in solid contents of 15-60 wt-%, preferably 20-60 wt-%, more preferably 30-60 wt-%,
the adduct solution is on-site the main process site modified by crosslinking for crosslinking polymers of the adduct solution to a ready-to-use polymer product, and
the ready-to-use polymer solution with the crosslinked polymers is provided to the main process as the process polymer on-site the main process site.

12. The method according to claim 11, wherein on-site the main process site before the crosslinking of the polymers of the adduct solution, the adduct solution is treated by charge formation, in particular by ring closing of the polymers of the adduct solution.

13. The method according to claim 11, wherein the adduct solution is diluted before the charge formation, in particular a ring closure and the crosslinking to maximum 30 wt-%, typically maximum 20 wt-%, even maximum 16 wt-%.

14. The method according to claim 11, wherein pH of the adduct solution is modified on-site the main process site, performing the charge formation, in particular the ring closure, advantageously such that pH value when being <pH 4 is modified to pH>6 in the charge formation, in particular in the ring closure, and wherein pH value is modified to be <pH 4 after the crosslinking.

15. The method according to claim 11, wherein solids content of the adduct solution is modified on-site the main process site to 8-45 wt %, preferably 10-30 wt %, more preferably 14-20 wt % in the crosslinking stage.

16. The method according to claim 11, wherein temperature of the adduct solution is modified on-site the main process site advantageously such that in the crosslinking the temperature range is 30-80° C. and that in the charge formation, in particular in the ring closure the temperature range is 40-80° C., preferably 45-60° C., to enhance the reaction.

17. The method according to claim 11, wherein a weight average molecular weight (Mw) of the polymer of the adduct solution prior to the charge formation is 2000-200 000 Da, preferably 3000-150 000 Da, more preferably 3000-100 000 Da, and in the crosslinking the weight average molecular weight (Mw) is 100 000-1000 000 Da, preferably 150 000-500 000 Da, more preferably 200 000-400 000 Da.

18. The method according to claim 11, wherein the crosslinking is performed continuously processing and the charge formation is performed continuously processing.

19. A system configured to execute the process according to claim 1, wherein the system comprises process equipment comprising devices for the crosslinking located in a movable construction configured to be located in connection with the main process for execution of the process.

20. The system according to claim 19, wherein the system comprises devices for the charge formation located in a movable construction configured to be located in connection with the main process.

21. The system of claim 19, wherein the system is configured to execute a method configured to modify polymers on-site at a main process site, wherein on-site the main process site:
an adduct solution for a crosslinked polymer product for a main process of the main process site is provided to the main process site as an interim polymer product for a process polymer of the main process site in solid contents of 15-60 wt-%, preferably 20-60 wt-%, more preferably 30-60 wt-%,
the adduct solution is on-site the main process site modified by crosslinking for crosslinking polymers of the adduct solution to a ready-to-use polymer product, and
the ready-to-use polymer solution with the crosslinked polymers is provided to the main process as the process polymer on-site the main process site.
